(19) United States
(12) Patent Application Publication
(10) Pub. No.: US 2007/0030111 A1
(43) Pub. Date: Feb. 8, 2007

(54) Humidity sensor

(76) Inventors: David B. Beck, West Jordan, UT (US); John A. Sindt, Sandy, UT (US); Thomas E. Danielson, Sandy, UT (US)

Correspondence Address: HOLME ROBERTS & OWEN, LLP, 299 SOUTH MAIN, SUITE 1800, SALT LAKE CITY, UT, 84111, US

(21) Appl. No.: 11/196,056

(22) Filed: Aug. 2, 2005

(51) Int. Cl. H01C 7/00

(52) U.S. Cl. 338/35

(57) ABSTRACT

A system and method for a resistor for detecting the relative level of moisture content in a humid environment. The resistor has a first layer of conductive material on a top surface of a substrate having a bend. The conductive material is exposed to atmospheric conditions. The first layer of conductive material has a static condition moisture content and a measurable electrical resistance that changes predictably when the amount of moisture content in contact with the first layer of conductive material changes from the static condition. The change of resistance of the first layer of conductive material corresponds to a change in the moisture content in contact with the first layer of electrically conductive material.

### BACKGROUND OF THE INVENTION

1. The Field of the Invention

This invention relates to electrical components and more particularly to sensors which vary in electrical resistance with humidity variation.

2. The Relevant Technology

Potentiometers are standard elements of electrical and electronic circuits. They are widely in use today for a variety of purposes including the measurement of mechanical movement. U.S. Pat. No. 5,157,372 (Langford) and U.S. Pat. No. 5,583,476 (Langford), (which are incorporated herein for all purposes), presented a new device identified as a flexible potentiometer that provided an electrical resistor having a consistent and predictable variable electrical output upon deflection or bending between configurations.

Flexible potentiometers have been sold commercially for measuring the amount of movement form a static configuration to a bent configuration. However, no flexible potentiometer is currently known that measures the amount of moisture content in contact with the surface of the device.

### BRIEF SUMMARY OF THE INVENTION

In various exemplary embodiments of the present invention, a deflectable resistor is provided. In general, the deflectable resistor comprises a substrate and a first layer of conductive material. The substrate is formed of a deflectable electrical insulating material having a top surface, a first end, a second end, a width and a length between said first end and said second end. The substrate is manufactured to have at least one bend.

A first layer of conductive material having a first end proximate said first end of said substrate, a second end proximate said second end of said substrate, a width and a length between said first end and said second end is disposed on the top surface of the substrate. The first layer of conductive material has a resistance measured between the first end and said second end of the first layer of conductive material that changes predictably when bent and an electrical signal is applied thereto. In general, the change of resistance of the first layer of conductive material reflects the amount of moisture content in contact with the first layer of conductive material.

In operation, the moisture contacting the surface of the humidity sensor penetrates a number of cracks in said first layer of conductive material. The space between the cracks in the first layer of conductive material fills with moisture and the resistance, therefore, decreases as the amount of moisture content increases.

In another preferred arrangement, the substrate is bendable between a first configuration and a second configuration. A layer of electrically conductive ink is deposited on a surface of the substrate. In a preferred configuration, the length and said width of the layer of electrically conductive ink is less than the length and said width of the substrate. The layer of conductive ink has a resistance measured between the first end and the second end of the layer of electrically conductive ink that changes predictably when bent and an electrical signal is applied thereto. The change of resistance of the layer of conductive ink reflects an amount of deflection between the first configuration and the second configuration.

In an alternate arrangement, the deflectable resistor further comprises a first connector means coupled to the first layer of electrically conductive ink for interconnection to external electrical components and a second connector means coupled to the layer of conductive material for interconnection to external electrical components.

In another preferred configuration, the first configuration of a substrate is a static configuration. Preferably, the static condition of the substrate is one where the substrate has at least one manufactured bend for use in a high humidity environment.

These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a top perspective view of a humidity sensitive sensor in accordance with the present invention;

FIG. 2 illustrates an exploded view the substrate, the first layer of conductive material, the first conductor and the second conductor;

FIG. 3 illustrates a top perspective view of a humidity sensitive sensor manufactured with a permanent bend in the substrate to facilitate sensing variations in a humid environment;

FIG. 4 illustrates a top view of the humidity sensitive resistor of FIG. 3;

FIG. 5 is a side view of the humidity sensitive resistor of FIG. 3;

FIG. 6 is a substantially enlarged cross-section view of a portion of a humidity sensitive resistor in a static position;

FIG. 7 is a substantially enlarged cross-section, right side view of a portion of a portion of a humidity sensitive resistor showing the conductive material and the first and second conductors;

FIG. 8 is a substantially enlarged cross-section, left side view of a humidity sensitive resistor showing the conductive material and the first and second conductors;

FIG. 9 shows a graph illustrating the correlation between resistance and humidity over time on the top surface of deflectable resistor.

### DESCRIPTION OF A PREFERRED EMBODIMENT

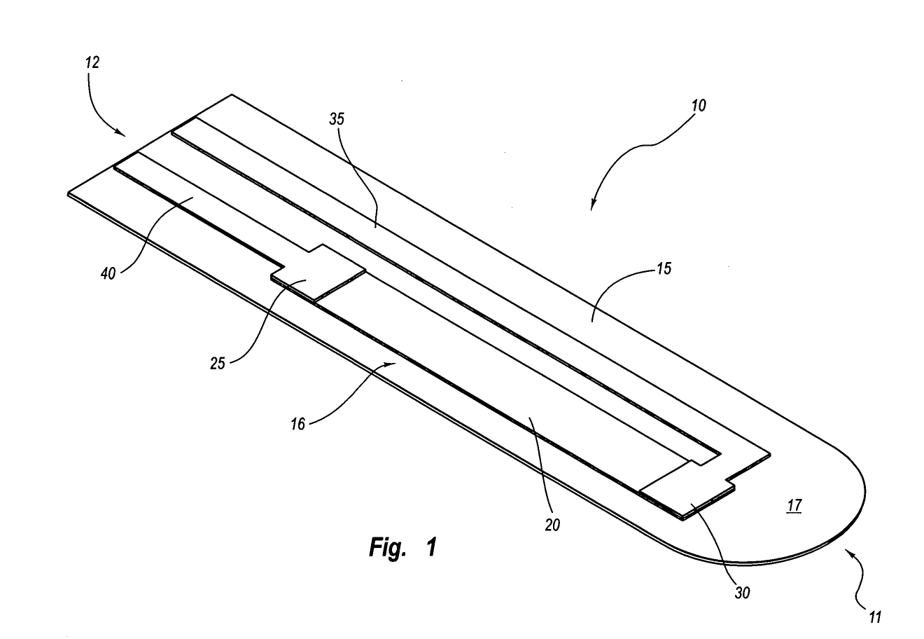

FIG. 1 illustrates a top perspective view of a humidity sensitive sensor 10. Humidity sensitive sensor 10 generally comprises a substrate 15 having both a top surface and a bottom surface and a layer of conductible material 16 disposed on one of the surfaces. The substrate 15 has a first end 11, a second end 12, a length that extends between the first end 11 and the second end 12 and a width. In the illustrated embodiment, the layer of variable resistance or conductible material 16 is disposed on the top surface of the substrate 15 of the humidity sensitive sensor 10.

Substrate 15 is formed of a deflectable insulating material. Various types of phenolic resin materials are presently believed to be suitable as the substrate. The substrate may also be constructed of various materials including various polymers, such as polyamide, polyimide (Kapton), and polyester (Mylar), which may be thermoplastics.

For applications involving multiple bending movements, a phenolic resin has been found to be particularly suitable. However, other materials may be suitable in selected applications. For example, the deflectable resistor may be used to measure inelastic deformation so that the substrate itself is inelastically deformable. Preferably, the substrate 15 should be deflectable without causing an electrical discontinuity or open circuit in the conductor means while generally maintaining its electrical insulating characteristics.

The conductible material or variable resistance material 16, also referred to herein as a conductor means, may be a two-part epoxy material, a thermoset adhesive, or a thermoplastic, all incorporating conductive material such as graphite or carbon. The variable resistance material may include a carbon ruthenium. To attach to a substrate, the conductible material 16 may include a material which facilitates wetting, gluing, or sticking. The conductible material 16 may include graphite in combination with a binder. The conductible material 16 is preferably of the type which is applied to the substrate in liquid form and which in turn dries to a solid form.

The conductible material 16 may be spray painted, rolled, silk screened, or otherwise printed onto the substrate. The variable resistance material may be a solid which is pressed onto the substrate. In some applications, a conductive substrate may be used. For other applications, the substrate may be connected to a particular potential, such as ground.

Merely examples, the substrate 15 may be from about 0.003 to about 0.007 inches in thickness (although various other thicknesses may be acceptable); the conductible material 16 may be from about 0.0006 to about 0.0011 inches in thickness (although various other thicknesses may be acceptable).

Humidity sensitive sensor 10 may be used to measure a change in the level of humidity or relative moisture content with respect to a starting or static moisture content or condition. The humidity sensitive sensor 10 is adapted to measure changes in a humidity factor ranging from 0% to 100%.

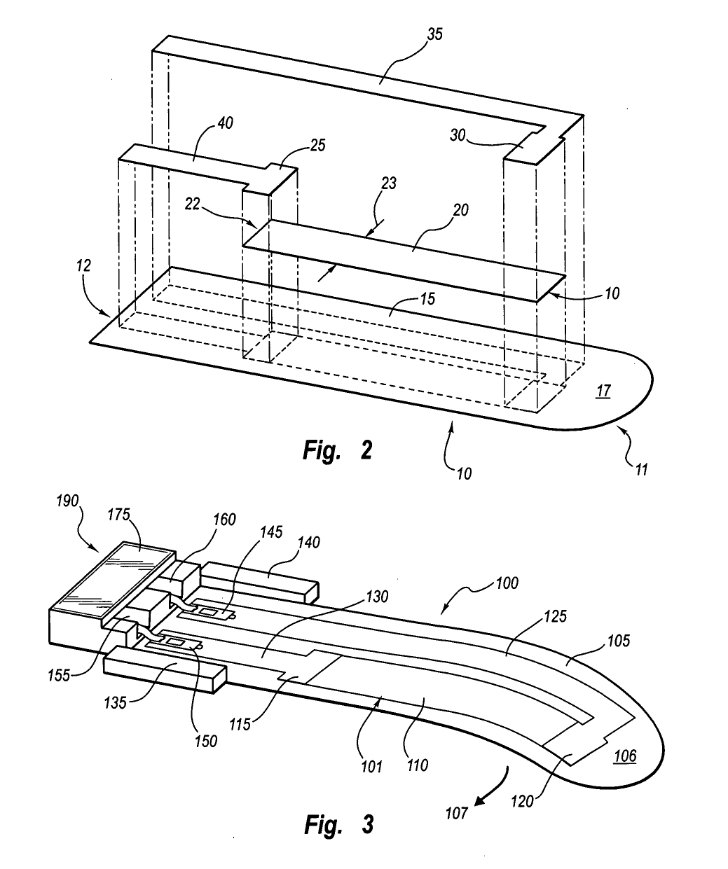

FIG. 2 illustrates an exploded view the humidity sensitive sensor 10 in accordance with one aspect of the present invention. In the illustrated embodiment, the top of humidity sensitive sensor 10 comprises a first top layer of electrically conductive ink 20 disposed on the top surface 17 of substrate 15. The first layer of electrically conductive ink 20 has a first end 21, a second end 22, a length extending from said first end to said second end and a width 23. The first end 21 of the layer of electrically conductive ink 20 is proximate the first end 11 of substrate 15. The second end 22 of the conductive ink layer 20 is proximate the second end 12 of substrate 15. In the illustrated embodiment, the length and width 23 of the electrically conductive ink layer 20 are both less than the length and the width of substrate 15.

It should be appreciated that the while illustrated embodiment illustrated in FIGS. 1 and 2 depicts a substrate 15 with a layer of conductive material 16 on the top surface, any number of shapes, sizes and lengths may be used. For example, humidity sensitive sensor 10 may comprise multiple legs having multiple layers of conductive material disposed on the top and/or bottom surface. In this manner, humidity sensitive sensor 10 may have two or more lengths, each having a layer of conductive material disposed thereon, with each of the layers of conductive material joined together by a run of conductive material.

As illustrated in FIG. 2, the first layer of conductive material 20 that is disposed on the top surface 17 is illustrated as suspended above the substrate 15. The first end segment 25 having a first conductive metal run 40 and the second end segment 30 having a second conductive metal run 35 are also shown suspended above the layer of conductive material 20. In operation, the resistance of conductive material 20 is measured between first conductor 25 and second conductor 30 by applying an electrical signal to the first conductive metal run 40 and the second conductive metal run 35. Accordingly, first conductive metal run 40 and second conductive metal run 35 terminate near the second end 12 to facilitate connection to a suitable supply.

Referring now to FIG. 3, a humidity sensitive sensor 100 is shown having a substrate 105 in a static position. In a humid environment, the static position for humidity sensor 100 is preferably defined by a curve or bend in the substrate 105. It has been discovered that providing a substantially flat substrate does not operate well in a humid environment. Therefore, it is optimum and thus preferred to provide a substrate 105 with a permanent bend or curve, as shown in both FIGS. 3 and 5, added during the manufacturing process or when the sensor 100 is installed in use.

Substrate length 105 has a first top layer of conductive material 101 disposed on the top surface 106 of substrate 105. In the illustrated embodiment, the conductive material comprises a first conductor 115 electrically coupled to one end of a layer of conductive ink 110 and a second conductor 120 electrically coupled to a second end of the layer of conductive ink 110. First conductor 115 is coupled to a first conductor run 130 and second conductor 120 is coupled to second conductor run 125. The first and second conductor runs 125, 130 terminate at the edge of substrate 105 to facilitate connecting to a connector 190.

It has also been found that, for measuring the moisture content in an environment having a variable level of humidity, the change of resistance is optimum when the conductive ink and the conductors are exposed to the environment. Accordingly, a top layer of protective coating that is typically applied to top surface 106 of substrate 105 to protect the conductors and the conductive ink is not applied for a sensor that is used to measure moisture content in a humid environment. As such, the conductors and the conductive ink is exposed to the atmosphere.

FIGS. 3, 4 and 5 together illustrate one embodiment of a connector 190 adhered to the bottom of substrate 110 and electrically coupled to conductor runs 125, 130. Connector 190 is but one of many possibilities, and is illustrated and described to show one method of measuring resistance from and applying a measuring signal to the sensor 100. Accordingly, the description of connector 190 provided herein is in no way intended to limit the use of other suitable connectors and should not be interpreted as such.

Connector 190 is adapted to provide an electrical signal to conductor runs 125, 130 and hence, first conductor 115 and second conductor 120, so as to measure the resistance of the conductive ink 110. Connector 190 comprises a left connector wall 135 and right connector wall 140. The width of substrate 105 matches the distance from left wall 135 to right wall 140, thereby creating a relatively tight fit when sliding the humidity sensor substrate 105 into the connector 190.

The substrate 105 rests against or in close proximity to the face of the connector housing 175 so as to bring first conductive run 125 and second conductor run 130 in close proximity to left connector channel 155 and right connector channel 160. In this way, the left electrical connector means 150 may be electrically coupled to the second conductor run 130 and the right electrical connector means 145 may be electrically coupled to the first conductor run 125. Right electrical connector means 145 extends into right connector channel 160 and electrically couples to right housing connector 165. Similarly, left electrical connector means 150 extends into left connector channel 155 and electrically couples to left housing connector 170. Left housing connector 170 and right housing connector 165 are electrically coupled to a pin receiving means (not shown) that is adapted for providing an electrical signal to the humidity sensor 100.

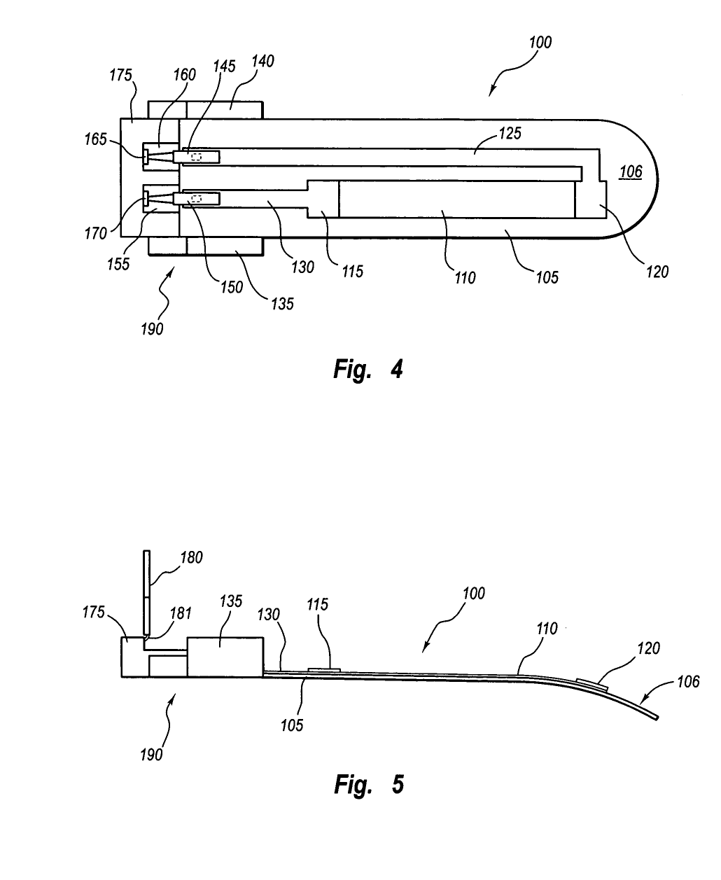

FIG. 5 illustrates a cover 180 and hinge 181 (not shown in FIGS. 3 and 4), adapted to fold between connector walls 135, 140. In so doing, cover 180 protects connector components comprising the housing connectors 165, 170, connector channels 155, 160 and electrical connectors 145 and 150. In operation, cover 180 is coupled to connector housing 175 by a thin piece of plastic material 181 that operates as a hinge. Cover 180 folds down towards the substrate 105 and between connector sides 135, 140, and snaps into place in grooves (not shown) in connector sides 135, 140 so as to form a tight fit and thereby a protective covering for the connector components.

In operation, when substrate 105 is exposed to moisture in the static configuration illustrated in FIGS. 3 and 5, the resistance of the first top layer of conductive material 101 predictably changes. The measurement of the change of resistance of the first top layer of conductive material 101 from the static configuration (i.e. a first condition having a first moisture content on the surface of substrate 105 defined to be the starting or static condition) to a condition with an elevated moisture content (i.e. a second condition having a second moisture content on the surface of substrate 105) reflects the change in moisture content or change in humidity.

Stated another way, the resistance of the sensor conductive ink 110 and the resistance of the moisture on the surface of the conductive ink 110 are two variables represented by the following equation:
1/Rₜₒₜₐₗ=1/Rₘₒᵢₛₜᵤᵣₑ+1/R_{conductive ink}
Since the sensor 100 is in a fixed bent configuration, the resistance of the conductive ink layer 110, R_{conductive ink}, is fixed and measurable. As the moisture content on the conductive ink changes, the resistance of the moisture content, Rₘₒᵢₛₜᵤᵣₑ, changes as well.

As the moisture level approaches 0%, the resistance of the moisture approaches infinity, and therefore the portion attributable to the moisture content, 1/Rₘₒᵢₛₜᵤᵣₑ, approaches zero. Accordingly, the resistance of the conductive ink layer 110 becomes visible and since R_{conductive ink} is fixed and measurable, 1/Rₜₒₜₐₗ is almost completely attributable to the resistance of the conductive ink layer 110. With measurements, a relationship between the resistance of the conductive ink layer 110 at a static condition, R_{conductive ink}, and the total resistance, Rₜₒₜₐₗ, of the conductive ink layer 110 exposed to humidity or moisture having a resistance Rₘₒᵢₛₜᵤᵣₑ can be developed and used in software or hardware, that is relatively simple to create.

Continuing with the operation of humidity sensitive sensor 100, micro-cracks (not shown) are added to the variable resistance material 101 during the manufacturing process. It is believed that as a sensor 100 (of some or all compositions) is bent, the distance between the micro-cracks of the variable resistance material 101 separates or widens. That is, in some or all compositions, dried variable resistance material has micro-cracks in a granular or crystalline-type structure which widens and separates upon deflection.

As the variable resistance material 101 bends, the number of cracks and the space between them is believed to increase, thereby changing the electrical resistance in a predictable manner. When the humidity sensor 100 is bent and moisture content is introduced to the surface, the change in resistance can then be measured upon application of suitable electrical signals. The change in resistance between the first configuration illustrated (static configuration) and a second configuration having a moisture content on the surface of the sensor 100 (not shown) can be measured upon the application of suitable electrical signals to first conductor run 125 and second conductor run 130.

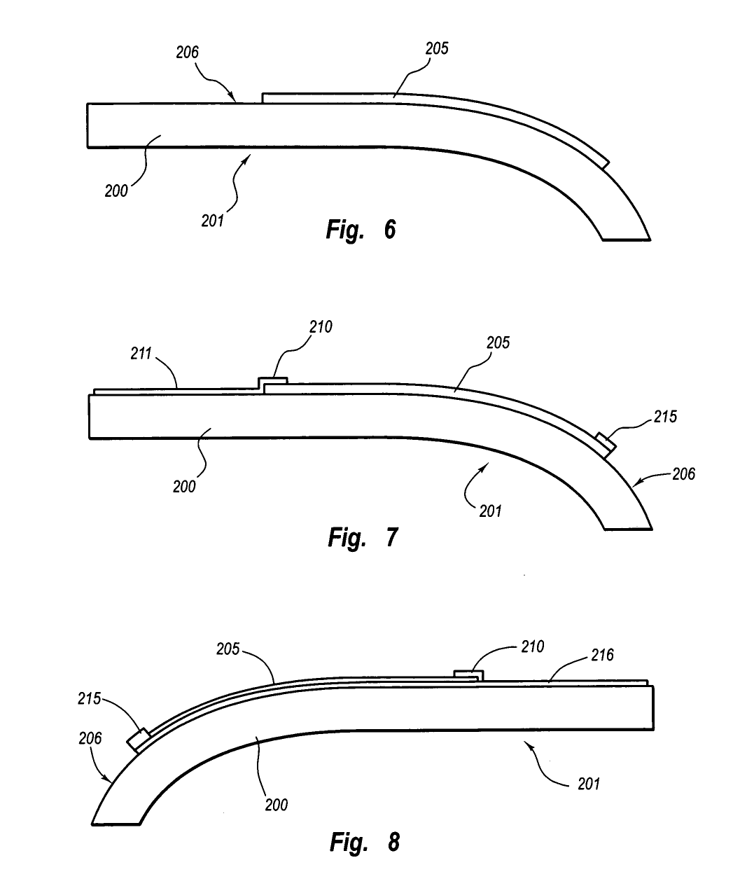

The sensor 201 of FIG. 6 is shown in side view and substantially enlarged view. Conductor means 205 is adhered to the top surface 206 of substrate 200. As shown in the left side view of FIG. 7, the sensor 201 includes a first conductor 210 and a second conductor 215 adhered to the surface of conductor means 205. The first conductor 210 has a first conductive run 211 that extends along the surface 206 of substrate 200. As shown in the right side view of FIG. 8, second conductor 215 has a second conductor run 216 that also extends along the top surface 206 of substrate 200.

The first conductor 210, second conductor 215 and first and second conductor runs 211, 216 are formed of an electrically conductive material. In one arrangement, the first conductor 210 and second conductor 215 have been successfully formed of silver. It is also believed formable from conductive silver alloys, and other conductive metals, as well as carbon-based compounds. In a preferred arrangement, the first conductor 210 and second conductor 215 are adhered to the conductive ink and, in turn, have a thickness which is from about 0.01 millimeters to about 0.02 millimeters and preferably about 0.015 millimeters.

The first conductor 210, second conductor 215 and first and second conductor runs 211, 216 retain their electrical conductivity upon deflection. With the first conductor 210 and second conductor 215 affixed or adhered to the conductor means 205, the resistance may still vary somewhat over time, but the degree of variance is either within acceptable tolerances or otherwise measurable from time to time so that adjustments can be made to accommodate for the drift in resistance over time.

Referring to FIGS. 6, 7 and 8, the substrate 200 is shown to have a thickness which is here shown substantially disproportionate to the true thickness of the substrate, solely to facilitate illustration. That is, for the substrate 200 to be elastically deflectable, it is preferred that its thickness be from about 0.07 to about 0.25 millimeters. If it is to be inelastically deflectable, the material and thickness must be appropriately selected.

The conductor means 205 of FIGS. 6, 7 and 8 is typically a conductive ink which is adhered to the top surface 206 of the substrate 200. By adhere, it is meant that the conductive ink is attached to the substrate, because the conductive ink includes a material which facilitates wetting, gluing, or sticking. A conductive ink suitable for the illustrated embodiment is available from Flexpoint Sensor Systems, 106 West 12200 South, Draper, Utah 84020 and identified as part number 365 or DOH 10 or variations thereof. The selected ink includes graphite in combination with a binder.

As illustrated in FIGS. 6, 7 and 8, the conductive ink 205 is deposited to adhere to the surface 206 of the substrate 200 and, in turn, has a thickness which is here illustrated substantially larger than the actual thickness. That is, the thickness of the layer of conductive ink 205 is illustrated disproportionate to the actual thickness of the substrate 200 and of the actual layer of the conductive ink 205. In the preferred embodiment, the thickness of the conductive ink 205 is from about 0.01 millimeters to 0.02 millimeter and desirably about 0.015 millimeters.

In typical sensor applications, a top layer of protective coating is added that protects the conductive ink 205, first and second conductors 210, 215 and first and second conductor runs 211, 216 from damage. As a humidity sensor, it has been found that such a protective coating inhibits the operation of the humidity sensor. Therefore, in the preferred embodiment, a final layer containing the top protective coating is not added to humidity sensitive sensor 201. Therefore, conductive ink 205, first and second conductors 210, 215 and first and second conductor runs 211, 216 are exposed to the atmosphere. In an alternative embodiment, the conductive ink 205 is exposed to the atmosphere and everything else, including first and second conductors 210, 215 and first and second conductor runs 211, 216 is protected by a top layer of protective coating.

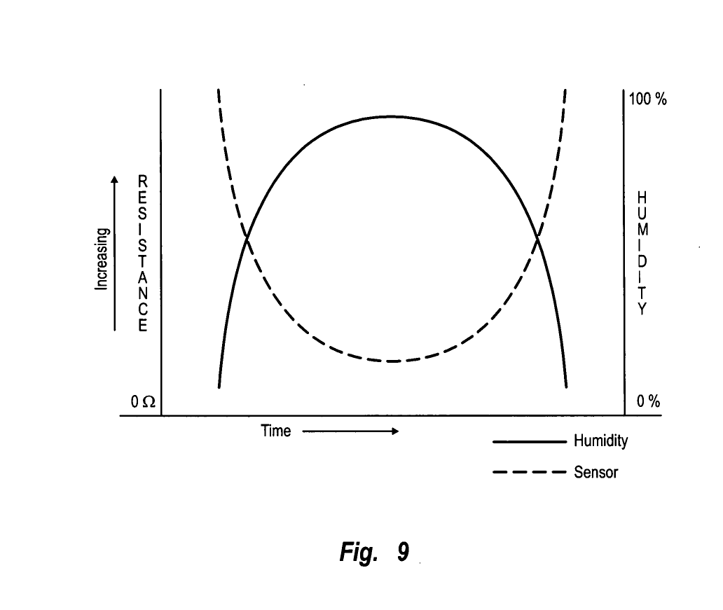

FIG. 9 shows a graph illustrating the correlation between resistance and moisture or humidity level. The x-axis of the graph is labeled time and the two y-axis are labeled humidity and resistance of the bend sensor material. In the illustrated graph for a typical example, as time increases along the x-axis, the amount of humidity that comes in contact with the bend sensor material 110 increases as well. As shown, the resistance of the bend sensor material decreases as the amount of moisture content increases. Accordingly, the resistance of the bend sensor material 110 changes in a measurable manner with respect to the moisture content and can be determined using a simple computer program or the like. Therefore, since there is a substantial one-to-one correlation between moisture content and resistance, a measurement of the moisture content in the atmosphere may be determined from the change in resistance of the material 110.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A humidity sensitive resistor comprising:
a substrate having a first surface and a second surface spaced from and generally opposite to said first surface, said substrate being in a configuration having at least one permanent bend;
a first layer of electrically conductive material disposed on said substrate in a desired configuration having a first end and a second end, said first layer of electrically conductive material exposed to atmospheric conditions and having a static condition moisture content, said first layer of electrically conductive material having an electrical resistance that changes predictably from said static condition moisture content when an amount of moisture content in contact with said first layer of conductive material changes from said static condition;
a second layer of electrically conductive material electrically connected to a first end of said first layer of conductive material; and
a third layer of electrically conductive material electrically connected to a second end of said first layer of conductive material.

2. The humidity sensitive resistor of claim 1 wherein said electrical resistance is dependent upon both the resistance of the first layer of electrically conductive material and the resistance of the moisture content in contact with said first layer of electrically conductive material.

3. The humidity sensitive resistor of claim 1 wherein said first layer of electrically conductive material, said second layer of electrically conductive material and said third layer of electrically conductive material are located on the top surface of said substrate.

4. The humidity sensitive resistor of claim 3 wherein a longitudinal x-axis extends along the length of said substrate and said permanent bend is in a direction that is generally in a negative y-direction relative to said longitudinal x-axis.

5. The humidity sensitive resistor of claim 1 further comprising an apparatus for holding said deflectable resistor in a fixed position, wherein said permanent bend is achieved by affixing said deflectable resistor to said apparatus.

6. The humidity sensitive resistor of claim 1 wherein said change of resistance of said first layer of conductive material reflects the amount of moisture content in the environment surrounding said deflectable resistor.

7. The humidity sensitive resistor of claim 1 wherein said static configuration moisture content is 0% relative humidity.

8. The humidity sensitive resistor of claim 7 wherein said change from said static configuration moisture content is greater than 0% relative humidity.

9. The humidity sensitive resistor of claim 8 wherein said change of electrical resistance between said static condition moisture content and said different moisture content in contact with said first layer of electrically conductive material corresponds to a relative humidity value.

10. The humidity sensitive resistor of claim 1 wherein said first layer of conductive material is a conductive ink.

11. The humidity sensitive resistor of claim 10 wherein said second layer of conductive material and said third layer of conductive material is made of a soft conductive metal.

12. The humidity sensitive resistor of claim 11, wherein said soft conductive metal is a silver or a silver alloy.

13. The humidity sensitive resistor of claim 1 wherein said permanent bend in said substrate widens a number of cracks in said first layer of conductive material, said cracks being wide enough for receiving said moisture content.

14. The humidity sensitive resistor of claim 13 wherein said moisture content comprises molecules of water.

15. The humidity sensitive resistor of claim 13 wherein a plurality of said cracks in said first layer of conductive material fill with moisture droplets as the amount of moisture content in contact with said first layer of conductive material increases and said electrical resistance measured between said first end and said second end decreases accordingly.

16. The humidity sensitive resistor of claim 1 further comprising:
a first connector means coupled to said second layer of conductive material for interconnection to external electrical components; and
a second connector means coupled to said third layer of conductive material for interconnection to external electrical components.

17. A humidity sensitive resistor comprising:
a substrate having a first surface and a second surface spaced from and generally opposite to said first surface, said substrate being in a configuration having at least one permanent bend;
a first layer of electrically conductive material disposed on said substrate in a desired configuration having a first end and a second end, said first layer of electrically conductive material exposed to atmospheric conditions, said first layer of electrically conductive material having a first resistance and a second resistance, said first resistance corresponding to a first condition having an amount of moisture content in contact with said first layer of electrically conductive material and said second resistance corresponding to a second condition having an amount of moisture content in contact with said first layer of electrically conductive material that is different than said first condition, the difference between said first resistance and said second resistance representing a change in moisture content in contact with said first layer of electrically conductive material.

18. The humidity sensitive resistor of claim 17, wherein said first condition has no moisture content.

19. The humidity sensitive resistor of claim 18, wherein said atmospheric condition associated with said first condition is 0% relative humidity.

20. The humidity sensitive resistor of claim 17, wherein said substrate has a length with a longitudinal x-axis extending along said length and wherein said permanent bend is in a direction in a negative y-direction relative to said longitudinal x-axis.

21. The humidity sensitive resistor of claim 17, further comprising:
a second layer of electrically conductive material electrically connected to said first end of said first layer of conductive material; and
a third layer of electrically conductive material electrically connected to said second end of said first layer of conductive material.

22. The humidity sensitive resistor of claim 21 wherein said second layer of electrically conductive material and said second layer of electrically conductive material are made of a soft conductive metal.

23. The humidity sensitive resistor of claim 22 wherein said soft conductive metal is a silver or a silver alloy.

24. The humidity sensitive resistor of claim 22 wherein said soft conductive metal is a carbon or a carbon compound.

25. The humidity sensitive resistor of claim 17 further comprising:
a first connector means coupled to said first end of said first layer of electrically conductive material for interconnection to external electrical components; and
a second connector means coupled to said second end of said first layer of electrically conductive material for interconnection to external electrical components.

26. A method for varying the resistance in an electrical circuit exposed to a humid environment, said method comprising:
providing a substrate having a first surface and a second surface spaced from and generally opposite to said first surface, said substrate being in a configuration having at least one permanent bend;
providing a first layer of electrically conductive material disposed on said substrate in a desired configuration having a first end and a second end, said first layer of electrically conductive material exposed to atmospheric conditions and having a static condition moisture content, said first layer of electrically conductive material having an electrical resistance that changes predictably from said static condition moisture content when an amount of moisture content in contact with said first layer of conductive material changes from said static condition;
providing a connector means for connection to external electrical components and said first and second end of said first layer of electrically conductive material;
connecting said connector means to said first and second end of said first layer of conductive material and said external electrical components in said electrical circuit;
applying an electrical signal to said first and second end of said first layer of conductive material; and
measuring a change of resistance of said first layer of conductive material to determine said amount of moisture content in contact with said first layer of electrically conductive material different than said static moisture content.

27. The method of claim 26 further comprising:
connecting a second layer of electrically conductive material electrically to a first end of said first layer of conductive material; and
connecting a third layer of electrically conductive material electrically to a second end of said first layer of conductive material.
